(19) United States
(12) Patent Application Publication
(10) Pub. No.: US 2006/0256513 A1
(43) Pub. Date: Nov. 16, 2006

(54) Structure for the display module of a portable computer

(76) Inventors: Shu-Hua Yeh, Taipei (TW); Ching-Ling Shen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/214,825

(22) Filed: Aug. 31, 2005

(30) Foreign Application Priority Data
May 12, 2005 (TW) 094207660

(51) Int. Cl. G06F 1/16

(52) U.S. Cl. 361/681; 361/683

(57) ABSTRACT

A structure for the display module of a portable computer is comprised of a first hinge connecting the body of a portable computer with a first arm, and the first arm connects and supports a display module; a second hinge connecting the body of the portable computer with a second arm, and the second arm connects and supports the display module; and a hard frame including a crossbeam, a first side and a second side, and the first side of the hard frame is connected with the first arm and the second side of the hard frame is connected with the second arm, such that the hard frame covers the first and second arms to provide better structural strength for the display module.

### FIELD OF THE INVENTION

The present invention generally relates to a structure of the display module of a portable computer, more particularly to an enhanced structure for a large display module of a portable computer.

### BACKGROUND OF THE INVENTION

In recent years, electronics and information industries are blooming, and related products becomes more precise day after day. In addition to the pursuance of a computing unit with faster and more powerful computing functions and various peripherals to satisfy user requirements in the personal computer area, a lightweight, thin, short and compact portable computer is also a key developing area in the industry.

Since a portable computer emphasizes on its portability, therefore the portable computer may be impacted by objects in the external environment during its transportation and use or compressed excessively due to the negligence of users, and thus resulting cracks or damages to a flat display module.

In R.O.C. Patent Application No. 90212717 entitled “Portable computer and its collision buffer device” filed on Jul. 26, 2001, a collision buffer device is installed at the edges and corners of the casing of a display of a portable computer. If the portable computer is collided by accident, the buffer device will provide a buffer function to the portable computer and protect the display and its internal components, and thus preventing the display from being damaged or cracked by the collision. However, the technology disclosed in such prior art only emphasizes on the design for protecting the edges and corners of the display panel, but does not provide a solution for protecting the display from being damaged by external forces coming from other directions.

In R.O.C. Patent Application No. 90204109 entitled “Enhanced frame structure of flat display” filed on Dec. 4, 2000, a metal frame is mounted onto the periphery of a liquid crystal display module to fix the components of the liquid crystal display. The metal frame according to such prior art usually adds a scraggy groove thereon by a sheet metal manufacturing method to enhance its structure strength. However, such metal frame tends to have a thin design to cope with the lightweight requirement, and thus lowering the strength and weakening the protection effect of the display panel.

Present consumers have high requirements on the size of a display panel of a portable computer, and the display panel is getting larger and larger. With the consideration of thin and lightweight characteristics of portable computers, the installation of a large display panel model of a portable computer has a much stricter requirement on the structural strength than that of a small display panel.

### SUMMARY OF THE INVENTION

Therefore, it is a primary objective of the present invention to provide a structure for the display panel of a portable computer, particularly an enhanced structure for the large display panel of a portable computer, which installs a hard frame around the periphery of a large screen of a portable computer to improve the structural strength of the screen and prevent the display panel from being damage or deformed caused by an external force or a torque of the hinge.

Another objective of the present invention is to use a hard frame to provide reinforcements and protections to the display module and overcome the shortcomings of the insufficient structural strength for the prior art large display module of a notebook computer.

A further objective of the present invention is to connect the frame with the screen hinge so as to diversify the torque and stress of a prior art hinge and extend the longevity of the hinge of a notebook computer. Since the prior arts generally emphasize on a solution for the computer hinge, the effect is insignificant and cannot be compared with the effect of the present invention that directly transfers the stress of the hinge onto an additional hard frame.

Another further objective of the present invention is to install an arm on the sides of the hard frame without ruining the external appearance of the computer display.

### BRIEF DESCRIPTION OF THE DRAWINGS

FIG. 1 is a top view of a hard frame of a preferred embodiment of the present invention;

FIG. 2 is a front view of a hard frame in accordance with a preferred embodiment of the present invention;

FIG. 3 is a cross-sectional view of a portion of the structure of a hard frame in accordance with a preferred embodiment of the present invention;

FIG. 4 is a perspective view of a first arm and a first hinge in accordance with a preferred embodiment of the present invention;

FIG. 5 is a planar view of a first arm and a first hinge in accordance with a preferred embodiment of the present invention;

FIG. 6 is a cross-sectional view of a first arm and a first hinge in accordance with a preferred embodiment of the present invention;

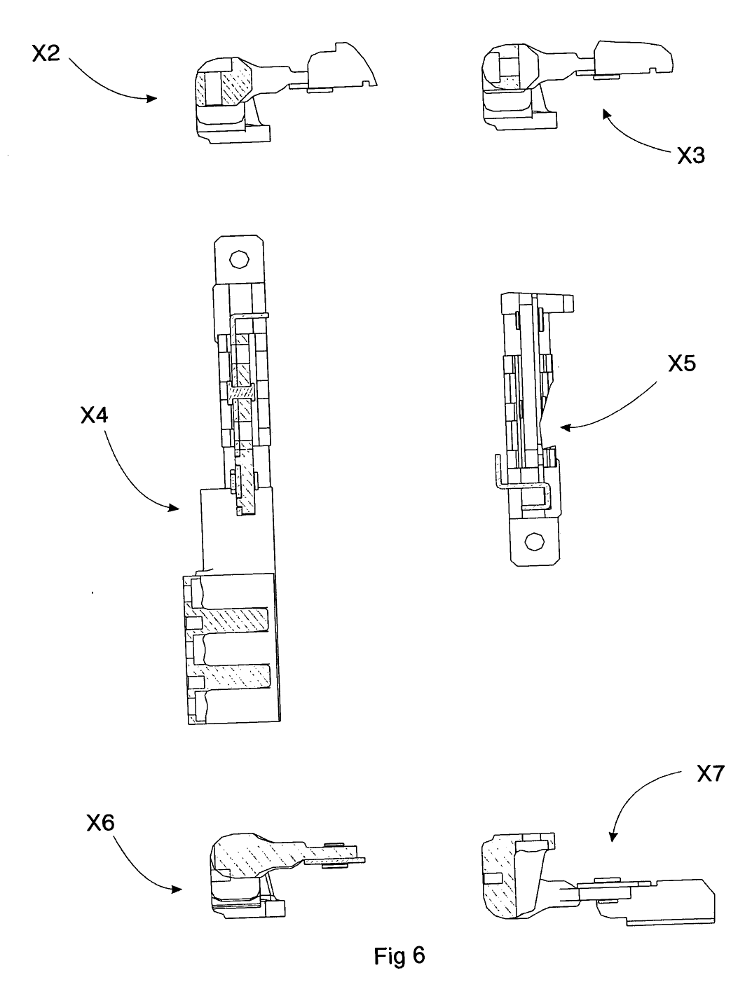

FIG. 7 is a perspective view of a second arm and a second hinge in accordance with a preferred embodiment of the present invention;

FIG. 8 is a planar view of a second arm and a second hinge in accordance with a preferred embodiment of the present invention;

FIG. 9 is a cross-sectional view of a portion of the structure of a second arm and a second hinge in accordance with a preferred embodiment of the present invention;

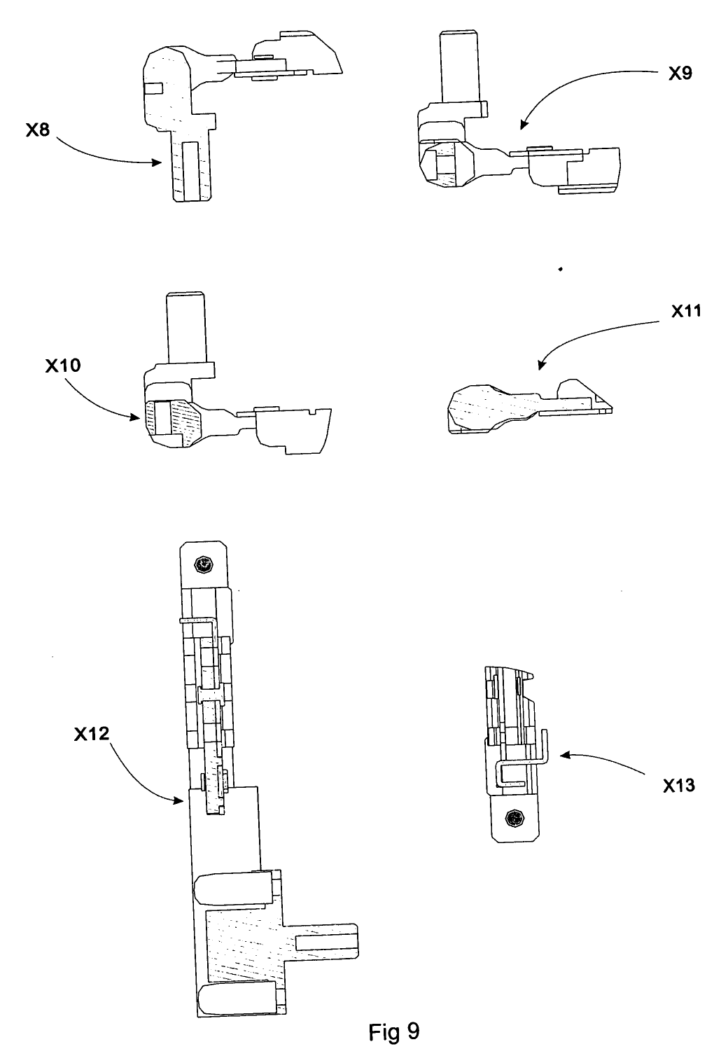

FIG. 10 is a planar view of a preferred embodiment of the present invention; and

FIG. 11 is a planar view of an application in accordance with a preferred embodiment of the present invention.

### DETAILED DESCRIPTION OF THE PREFERRED EMBODIMENTS

The above and other objects, features and advantages of the present invention will become apparent from the following detailed description of two preferred embodiments taken with the accompanying drawings.

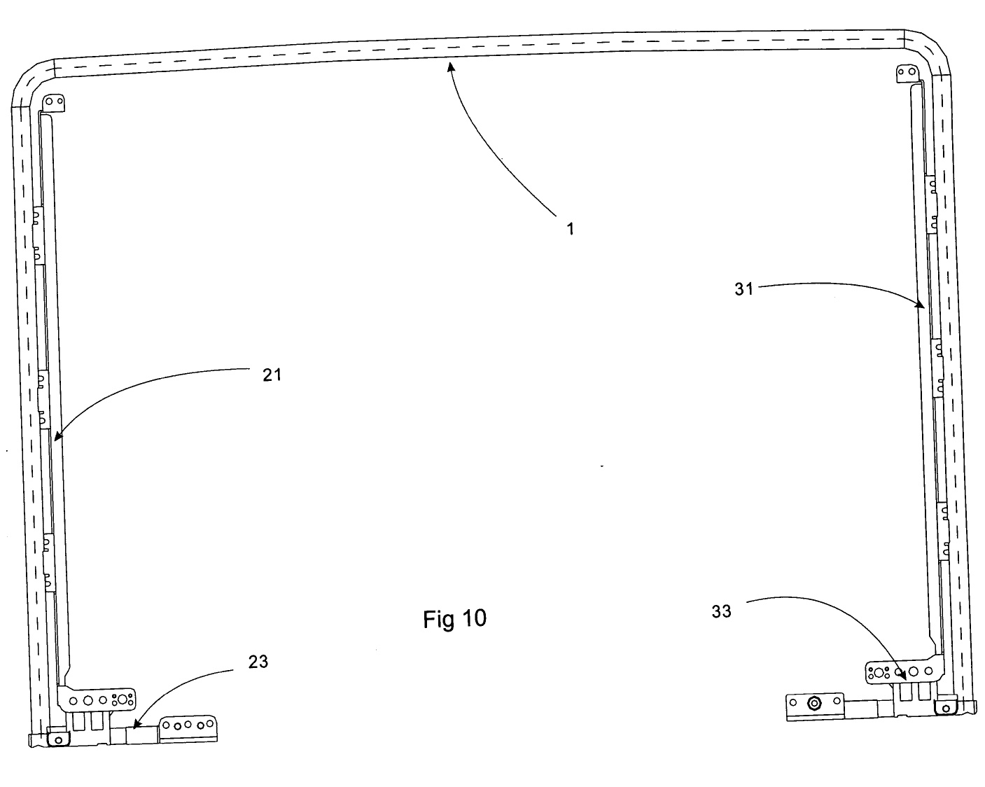

Referring to FIG. 10 for a structure of the display module of a portable computer, the structure comprises a first hinge 23, a first arm 21, a second hinge 33, a second arm 31 and a hard frame 1.

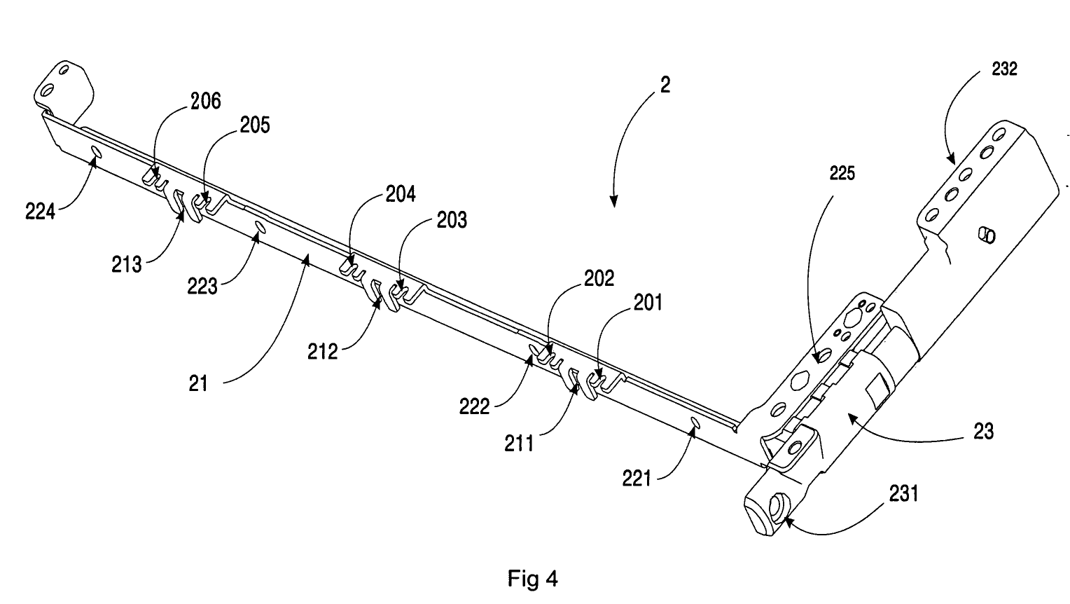

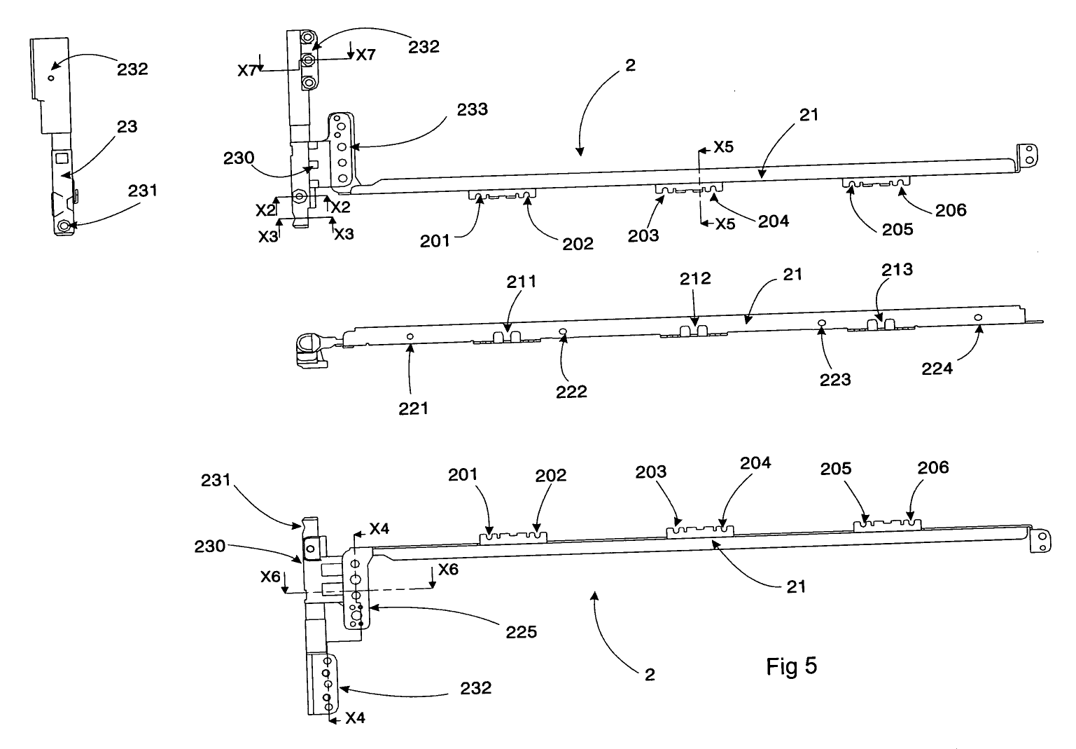

In FIGS. 4 and 5, the first hinge 23 comprises a main system body fixing 232 and a first arm fixing section 233, wherein the main system body fixing section 232 is connected to a body of the main system and preferably secured by screws, and the main system body connecting section 232 can be connected according to the setup of the body of the main system and is not limited to the foregoing way. The first arm fixing section 233 is connected with the first arm 21.

In FIGS. 4 and 5, the first arm 21 comprises a plurality of panel module connecting sections 221, 222, 223, 224 and a first hinge fixing section 225. The plurality of panel module connecting sections 221, 222, 223, 224 are disposed on the body of the first arm 21, and the hinge fixing section 225 is extended substantially perpendicular to the plurality of panel module connecting sections 221, 222, 223, 224. The hinge fixing section 225 is connected to the first arm fixing section 233 of the first hinge 23, and preferably secured by rivets. The body of the first arm 21 has a plurality of plurality of panel module connecting sections 221, 222, 223, 224 connected to one side of a display module and preferably secured by screws. However, the panel module connecting section 221, 222, 223, 224 can be connected according to the setup of the display module, and is not limited to the foregoing way. The first arm 21 at its external edge comprises a plurality of hard frame fixing sections 211, 212, 213.

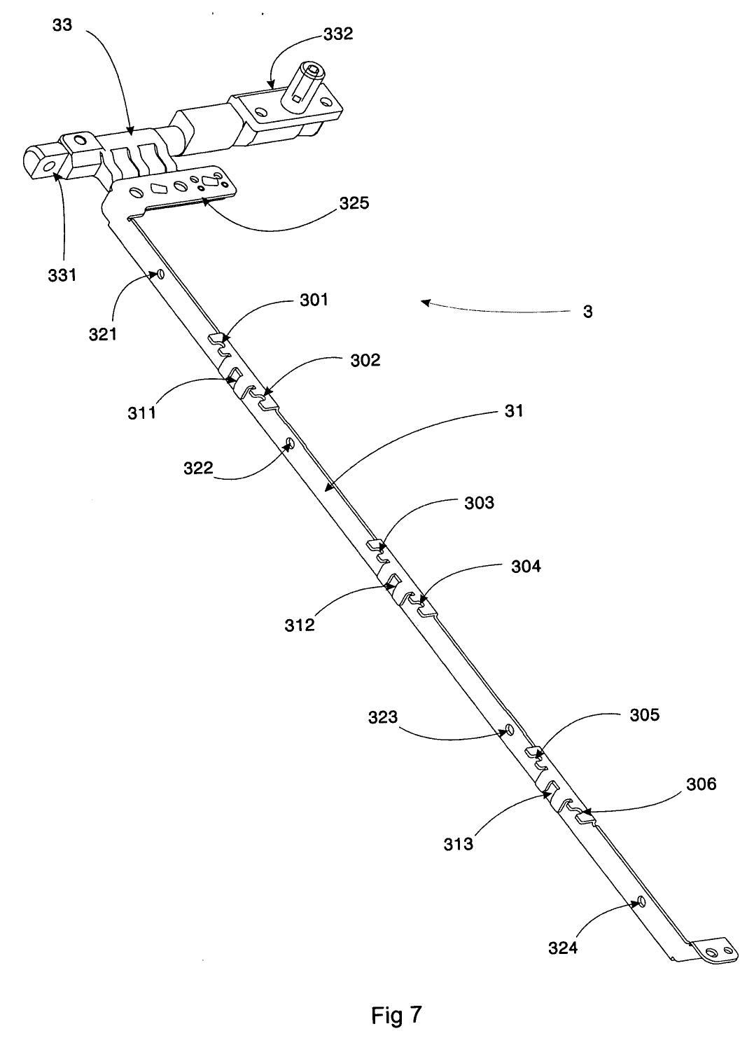

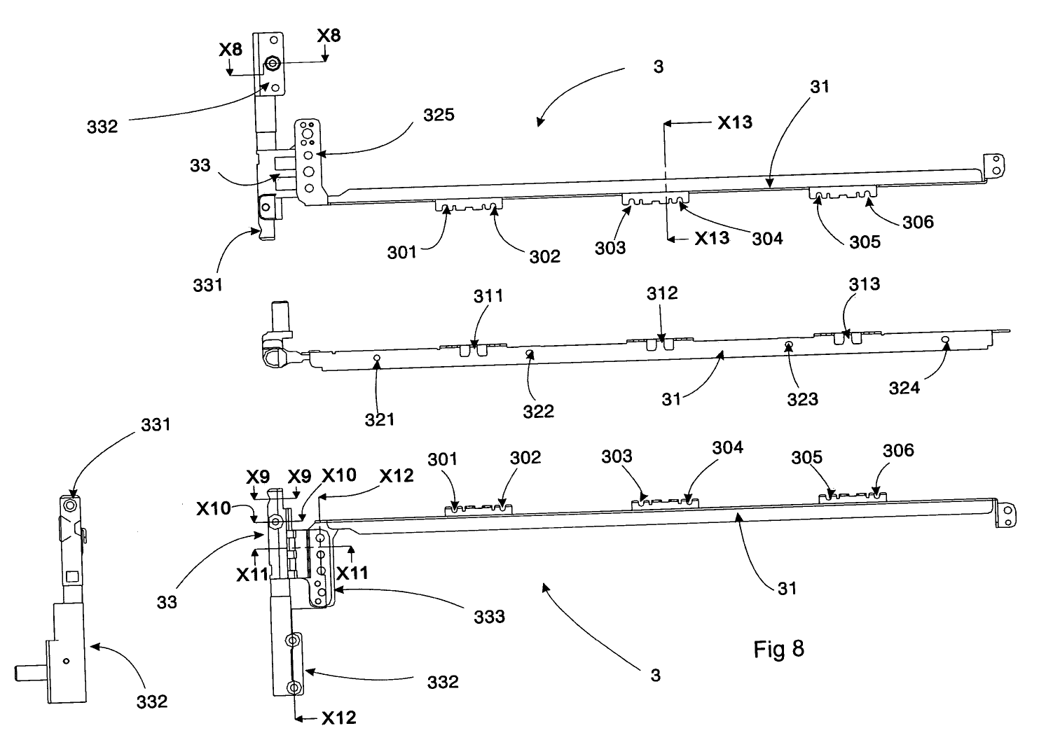

Referring to FIGS. 7 and 8, the second hinge 33 comprises a main system body fixing section 332 and a second arm fixing section, 333, wherein the main system body fixing section 332 is connected to a body of the main system and preferably secured by screws, and the main system body connecting section 332 can be connected according to the setup of the body of the main system and is not limited to the foregoing way. The second arm fixing section 333 is connected with the second arm 31.

In FIGS. 7 and 8 the second arm 31 comprises a plurality of panel module connecting sections 321, 322, 323, 324 and a second hinge fixing section 325. The plurality of panel module connecting sections 321, 322, 323, 324 are disposed on the body of the second arm 31, and the hinge fixing section 325 is extended substantially perpendicular to the plurality of panel module connecting sections 321, 322, 323, 324. The hinge fixing section 325 is connected to the second arm fixing section 333 of the second hinge 33, and preferably secured by rivets. The body of the second arm 31 has a plurality of panel module connecting sections 321, 322, 323, 324 connected to one side of a display module and preferably secured by screws. However, the panel module connecting sections 321, 322, 323, 324 can be connected according to the setup of the display module, and is not limited to the foregoing way. The second arm 31 at its external edge comprises a plurality of hard frame fixing sections 311, 312, 313.

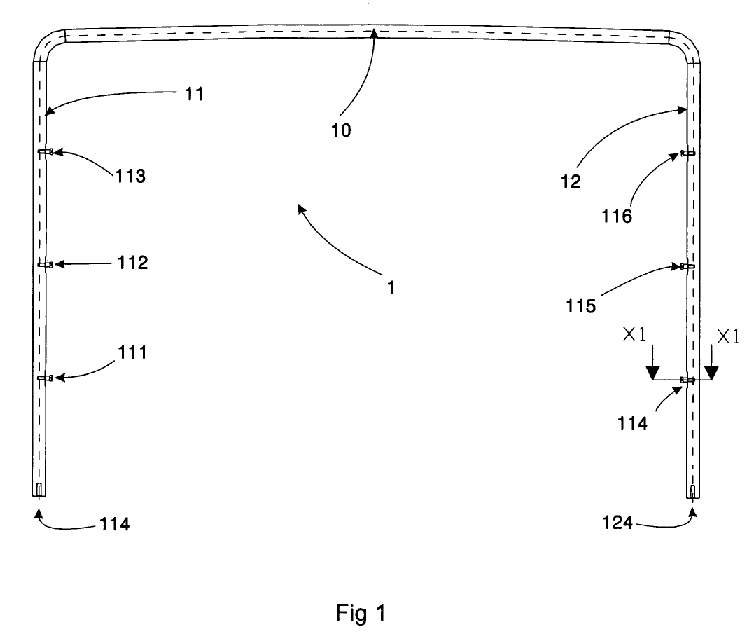

In FIG. 1, the hard frame 1 comprises a crossbeam 10, a first side 11 and a second side 12, and the first side is extended from an end of the crossbeam 10 in a direction substantially perpendicular to the crossbeam 10, and the second side 12 is extended from another end of the crossbeam 10 in a direction substantially perpendicular to the crossbeam 10. The first and second sides 11, 12 at their internal edges comprise a plurality of first arm fixing sections 111, 112, 113 and a plurality of second arm fixing sections 114, 115, 116, wherein the plurality of first arm fixing sections 111,112,113 of the first side 11 of the hard frame 1 are connected to the plurality of hard frame fixing sections 211, 212, 213 of the first arm 21. The plurality of second arm fixing sections 114, 115, 116 of the second side 12 of the hard frame 1 are connected with the plurality of the hard frame fixing sections 311, 312, 313 of the second arm 31, such that the hard frame 1 covers the first arm 21 and the second arm 31.

Compared with the prior art, the foregoing structure adds a hard frame 1 to cover the first arm 21 and the second arm 31, and thus achieving a better overall structural strength of the structure, particularly for the large display panel of a portable computer. The structure of the invention can greatly reduce external forces exerted on the structure, or even reduce the deformation of the display module caused by opening and shutting the display panel under normal use, and thus further preventing damages to the panel module. Unlike the prior art, the hard frame 1 of the invention adds a crossbeam 20 to provide better protection against any external force exerted onto the top of the display module.

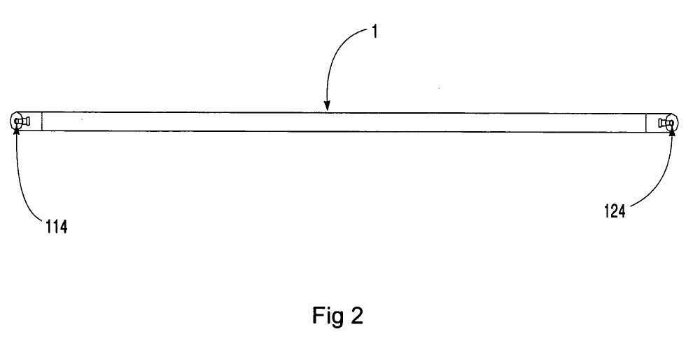

Referring to FIGS. 4 and 5, the first hinge 23 further includes a hard frame fixing section 231 disposed on one side of the first hinge 23. In FIGS. 7 and 8, the second hinge 33 further includes a hard frame fixing section 331 at one side of the second hinge 33. In FIGS. 1 and 2, the first side 11 of the hard frame 1 further includes a first hinge fixing section 114 disposed at an end of the first side 11, and the second side 12 of the hard frame 1 further includes a second hinge fixing section 124 at an end of the second side 12, so that the first hinge fixing section 114 of the hard frame 1 is connected to the hard frame fixing section 231 of the first hinge 23, and the second hinge fixing section 124 of the hard frame 1 is connected to the hard frame fixing section 331 of the second hinge 33 and preferred secured by screws. In FIGS. 4 and 7, the hard frame fixing section 231 of the first hinge 23 and the hard frame fixing section 331 of the second hinge 33 are through slots. In FIG. 2, the first hinge fixing section 114 and the second hinge fixing section 124 of the hard frame 1 separately have a groove hole with a spiral groove, and thus the first hinge fixing section 114 of the hard frame 1 and the hard frame fixing section 231 of the first hinge 23 are secured by screws; and the second hinge fixing section 124 of the hard frame 1 and the hard frame fixing section 331 of the second hinge 33 are also secured by screws.

Compared with the prior arts, the structure of the present invention connects the hard frame 1 with the first hinge 23 and the second hinge 33 to directly and effectively diversify the torque and stress of the hinge and extend the longevity of the hinge of a notebook computer. Most prior arts emphasize on the hinge, but the effect is very limited, which cannot achieve the effect of spreading the stress of the hinge directly onto an external hard frame 1 as the present invention does.

In FIG. 1, the first arm fixing sections 111, 112, 113 and the second fixing section 114, 115, 116 of the hard frame are protruded components. In FIGS. 4 and 7, the hard frame fixing section 211, 212, 213 of the first arm 21 and the hard frame fixing sections 311, 312, 313 of the second arm 31 are latch groove components, such that the protruded components and the latch groove components can be latched with each other.

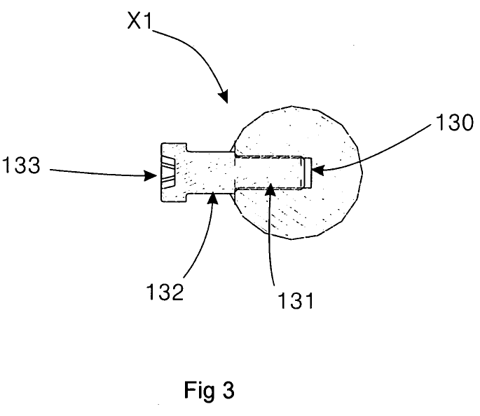

Referring to FIG. 3, a cross-sectional view of Section X1-X1 is illustrated. In FIG. 3, the protruded component includes a root section 131, a neck section 132 and a blocking section 133. The root section 131 is embedded into the slot 130 at the internal side of the hard frame 1; the neck section 132 is latched into the latch groove components of the hard frame fixing sections 211, 212, 213 of the first arm 21 and the hard frame fixing sections 311, 312, 313 of the second arm 31; and the blocking section 133 maintains the latch condition between the protruded components and the latch groove components. Preferably, the root section 131 of the protruded components is surrounded by a spiral groove that can be embedded spirally into the hard frame slot 130.

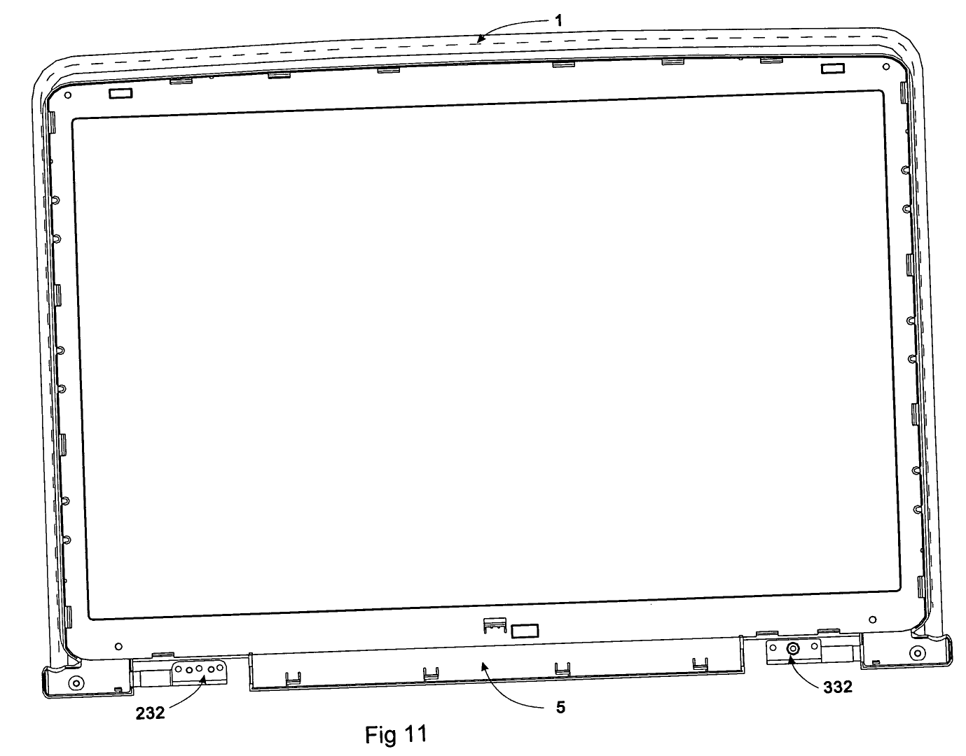

In FIGS. 10 and 11, the structure of the present invention completely hides the fixing sections and components without ruining the external appearance by connecting the hard frame 1 with the first arm 21 and second arm 31 as well as installing an upper panel 5 of the panel module.

Further, the hard frame 1 is preferably made of an aluminum alloy, an aluminum-magnesium alloy or a titanium alloy. Although the invention focuses on the design of a large display module for notebook computers, yet it is not limited to the large display module, but also provides a strong structure for display modules other than the large ones.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A structure for the display module of a portable computer, comprising:
a first hinge, including a main system body fixing section for connecting a body of a main system and a first arm fixing section for connecting a first arm;
a first arm, including a plurality of panel module connecting sections disposed on a body of said first arm and a hinge fixing section extended substantially perpendicular to said plurality of panel module connecting section, and said hinge fixing section connects said first arm fixing section of said first arm, and said plurality of panel module connecting sections on a body of said first arm connects a side of a display module;
a second hinge, including a main system body fixing section for connecting a body of said main system and a second arm fixing section for connecting said second arm;
a second arm, including a plurality of panel module connecting sections disposed at an internal edge of said second arm and a hinge fixing section extended substantially perpendicular to said plurality of panel module connecting sections, and said hinge fixing section couples said second arm of said second hinge and said plurality of panel module connecting sections couple another side of said display module; characterized in that:
a hard frame, including a crossbeam, a first side and a second side, and said first side is extended substantially perpendicular at an end of said crossbeam, and said second side is extended substantially perpendicular to another end of said crossbeam; said first side and said second side include a plurality of first arm fixing sections and a plurality of second arm fixing sections respectively disposed on their internal edges, and said first arm further comprises a plurality of hard frame fixing sections at its external edge, and said second arm further comprises a plurality of hard frame fixing sections at its external edge, wherein said plurality of first arm fixing sections of said first side of said hard frame are coupled with said hard frame fixing sections of said first arm, and said plurality of second arm fixing sections of said second side of said hard frame are coupled with said hard frame fixing sections of said second arm, such that said hard frame covers said first and second arms.

2. The structure for the display module of a portable computer of claim 1, wherein said first hinge further comprises a hard frame fixing section at one side and said second hinge further comprises a hard frame fixing section at one side, and said hard frame at said first side further comprises a first hinge fixing section, and said hard frame at said second side further comprises a second hinge fixing section; and
said first hinge fixing section of said hard frame is coupled with said hard frame fixing section of said first hinge, and said second hinge fixing section of said hard frame is coupled with said hard frame fixing section of said second hinge.

3. The structure for the display module of a portable computer of claim 2, wherein said first arm fixing section and said second arm fixing section of said hard frame are protruded components, and said hard frame fixing section of said first arm and said hard frame fixing section of said second arm are latch groove components, such that said protruded components are latched into said latch groove components.

4. The structure for the display module of a portable computer of claim 3, wherein said protruded component comprises a root section disposed in a slot at an internal side of said hard frame, a neck section latched into said latch groove of said hard frame fixing section of said first arm and said latch groove component of said hard frame fixing section of said second arm, and a blocking section for maintaining a latch condition between said protruded components and said latch groove components.

5. The structure for the display module of a portable computer of claim 4, wherein said root section of said protruded component is surrounded by a spiral groove.

6. The structure for the display module of a portable computer of claim 5, wherein said root section of said protruded component is embedded into said hard frame slot.

7. The structure for the display module of a portable computer of claim 2, wherein said hard frame fixing section of said first hinge and said hard frame fixing section of said second hinge are through slots, and said first hinge fixing section and said second hinge fixing section said hard frame separately have a spiral slot, and said first hinge fixing section of said hard frame is secured with said hard frame fixing section of said first hinge by a screw, and said second hinge fixing section of said hard frame is secured with said hard frame fixing section of said second hinge by a screw.

8. The structure for the display module of a portable computer of claim 3, wherein said hard frame fixing section of said first hinge and said hard frame fixing section of said second hinge are through slots, and said first hinge fixing section and said second hinge fixing section said hard frame separately have a spiral slot, and said first hinge fixing section of said hard frame is secured with said hard frame fixing section of said first hinge by a screw, and said second hinge fixing section of said hard frame is secured with said hard frame fixing section of said second hinge by a screw.

9. The structure for the display module of a portable computer of claim 3, wherein said hard frame is made of an aluminum alloy, an aluminum-magnesium alloy or a titanium alloy.

10. A portable computer, having a body of a main system and a display unit, wherein a structure of the display module of a display unit comprising:
a first hinge, including a main system body fixing section for connecting a body of a main system and a first arm fixing section for connecting a first arm;
a first arm, including a plurality of panel module connecting sections disposed on a body of said first arm and a hinge fixing section extended substantially perpendicular to said plurality of panel module connecting section, and said hinge fixing section connects said first arm fixing section of said first arm, and said plurality of panel module connecting sections on a body of said first arm connects a side of a display module;
a second hinge, including a main system body fixing section for connecting a body of said main system and a second arm fixing section for connecting said second arm;
a second arm, including a plurality of panel module connecting sections disposed at an internal edge of said second arm and a hinge fixing section extended substantially perpendicular to said plurality of panel module connecting sections, and said hinge fixing section couples said second arm of said second hinge and said plurality of panel module connecting sections couple another side of said display module; characterized in that said structure of the display module of a display unit further comprising:
a hard frame, including a crossbeam, a first side and a second side, and said first side is extended substantially perpendicular at an end of said crossbeam, and said second side is extended substantially perpendicular to another end of said crossbeam; said first side and said second side include a plurality of first arm fixing sections and a plurality of second arm fixing sections respectively disposed on their internal edges, and said first arm further comprises a plurality of hard frame fixing sections at its external edge, and said second arm further comprises a plurality of hard frame fixing sections at its external edge, wherein said plurality of first arm fixing sections of said first side of said hard frame are coupled with said hard frame fixing sections of said first arm, and said plurality of second arm fixing sections of said second side of said hard frame are coupled with said hard frame fixing sections of said second arm, such that said hard frame covers said first and second arms.

11. The structure for the display module of a portable computer of claim 10, wherein said first hinge further comprises a hard frame fixing section at one side and said second hinge further comprises a hard frame fixing section at one side, and said hard frame at said first side further comprises a first hinge fixing section, and said hard frame at said second side further comprises a second hinge fixing section; and
said first hinge fixing section of said hard frame is coupled with said hard frame fixing section of said first hinge, and said second hinge fixing section of said hard frame is coupled with said hard frame fixing section of said second hinge.

12. The structure for the display module of a portable computer of claim 11, wherein said first arm fixing section and said second arm fixing section of said hard frame are protruded components, and said hard frame fixing section of said first arm and said hard frame fixing section of said second arm are latch groove components, such that said protruded components are latched into said latch groove components.

13. The structure for the display module of a portable computer of claim 12, wherein said protruded component comprises a root section disposed in a slot at an internal side of said hard frame, a neck section latched into said latch groove of said hard frame fixing section of said first arm and said latch groove component of said hard frame fixing section of said second arm, and a blocking section for maintaining a latch condition between said protruded components and said latch groove components.

14. The structure for the display module of a portable computer of claim 13, wherein said root section of said protruded component is surrounded by a spiral groove.

15. The structure for the display module of a portable computer of claim 14, wherein said root section of said protruded component is embedded into said hard frame slot.

16. The structure for the display module of a portable computer of claim 11, wherein said hard frame fixing section of said first hinge and said hard frame fixing section of said second hinge are through slots, and said first hinge fixing section and said second hinge fixing section said hard frame separately have a spiral slot, and said first hinge fixing section of said hard frame is secured with said hard frame fixing section of said first hinge by a screw, and said second hinge fixing section of said hard frame is secured with said hard frame fixing section of said second hinge by a screw.

17. The structure for the display module of a portable computer of claim 12, wherein said hard frame fixing section of said first hinge and said hard frame fixing section of said second hinge are through slots, and said first hinge fixing section and said second hinge fixing section said hard frame separately have a spiral slot, and said first hinge fixing section of said hard frame is secured with said hard frame fixing section of said first hinge by a screw, and said second hinge fixing section of said hard frame is secured with said hard frame fixing section of said second hinge by a screw.

18. The structure for the display module of a portable computer of claim 10, wherein said hard frame is made of an aluminum alloy, an aluminum-magnesium alloy or a titanium alloy.
